(19) United States
(12) Patent Application Publication
(10) Pub. No.: US 2006/0044469 A1
(43) Pub. Date: Mar. 2, 2006

(54) Apparatus and method for coordinating synchronization of video and captions

(75) Inventors: In-hwan Kim, Suwon-si (KR); Jin-woo Hong, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/212,566

(22) Filed: Aug. 29, 2005

(30) Foreign Application Priority Data
Aug. 28, 2004 (KR) 10-2004-0068257

(51) Int. Cl. H04N 9/475; H04N 5/445

(52) U.S. Cl. 348/515; 348/512; 348/564

(57) ABSTRACT

An apparatus and a method for coordinating synchronization of video and captions by delaying the output of video or captions for a predetermined period of time, or by controlling synchronization information of the caption data are provided. The apparatus for coordinating synchronization of video and captions includes a first decoding unit to decode video data, a second decoding unit to decode caption data, and an output control unit to control the output time of the decoded caption data and the decoded video data according to predetermined control information.

### CROSS-REFERENCE TO RELATED APPLICATION

This application claims priority from Korean Patent Application No. 10-2004-0068257 filed on Aug. 28, 2004, the disclosure of which is incorporated herein in its entirety by reference.

### BACKGROUND OF THE INVENTION

1. Field of the Invention

Apparatuses, systems and methods consistent with the present invention relate to coordinating synchronization of video and captions. More particularly, the present invention relates to an apparatus and a method for coordinating synchronization of video and captions by delaying the output of video or captions for a predetermined period of time, or by controlling synchronization information of the caption data.

2. Description of the Related Art

Recently, captioned broadcasts have become popular. These broadcasts caption a speaker's words. The captioned broadcasts are provided mainly for the deaf, hard-of-hearing people, language learners, and for broadcast receiving apparatuses installed in places where the sound volume should be lowered or muted (e.g., inside subways and lobbies of buildings).

FIG. 1 is a block diagram illustrating a related art captioned broadcast receiving apparatus.

When broadcast signals are first received through a frequency tuning operation performed by a tuning unit 110, an inverse multiplexing unit 120 separates video data, audio data, and caption data from the input broadcast signals.

Video data and audio data are decoded by an audio/video decoding unit 130 and caption data is decoded by a caption decoding unit 140.

Afterwards, an output unit 150 outputs the decoded audio data and decoded video/caption data through a speaker (not shown) and a monitor (not shown), respectively. The output unit 150 also controls whether to display the captions, at a user's request.

The related art captioned broadcast receiving apparatus displays the received captioned broadcast without a separate operation to coordinate synchronization of the video/audio and captions. In some cases, inappropriate synchronization of the video/audio and captions may inconvenience the user.

For example, in the case of live broadcasting, a broadcasting station produces caption data to be displayed together with video in real time. To produce the caption data, a shorthand writer listens to the broadcast and types text corresponding to the content, or a voice-to-text transformer converts the received speech input into text. For this reason, the caption data may be produced later than corresponding video and audio data. This delay is caused because it takes time to create the caption data (hereinafter, this time will be referred to as the “delay time”). Likewise, the video and audio data are broadcasted earlier than the caption data by the delay time.

The captioned broadcast receiving apparatus provides these captioned broadcasts to users as they are, and thus, the captions provided to the users may be displayed later than the corresponding video and audio by the delay time (t), as illustrated in FIG. 2.

FIG. 2 is a timing diagram of video and caption output according to the related art. High values of a video and a caption indicate the time during which the video or the caption is being displayed. As depicted therein, when contents, A, B and C are displayed, display of the caption corresponding to each video is delayed by the time t. This mismatched output hinders the viewing of the broadcast.

In the case of captioned broadcasts produced in advance, e.g., recorded broadcasts, synchronization of the video and the concerned captions are coordinated in advance. However, even in this case, the user may want to control the timing of caption display. For example, when the user is a language learner, he/she may want to precede or delay output of the captions by a specific time.

Accordingly, there is a need for a technology which can coordinate synchronization of video and captions based on user input.

### SUMMARY OF THE INVENTION

An object of the present invention is to coordinate synchronization of video and captions based on the user's demand.

Other objects of the invention will be more readily understood by those in the art from the following detailed description.

According to an aspect of the present invention, there is provided an apparatus for coordinating synchronization of video and captions, comprising a first decoding unit to decode video data; a second decoding unit to decode caption data; and an output control unit to control the output time of the decoded caption data and the decoded video data according to predetermined control information.

According to another aspect of the present invention, there is provided a method for coordinating synchronization of video and captions, comprising decoding video data; decoding caption data; and controlling output of the decoded caption data and the decoded video data according to predetermined control information.

### BRIEF DESCRIPTION OF THE DRAWINGS

The above aspects and other features and advantages of the present invention will become more apparent by describing in detail exemplary embodiments thereof with reference to the attached drawings in which:

FIG. 1 is a block diagram illustrating a related art captioned broadcast receiving device;

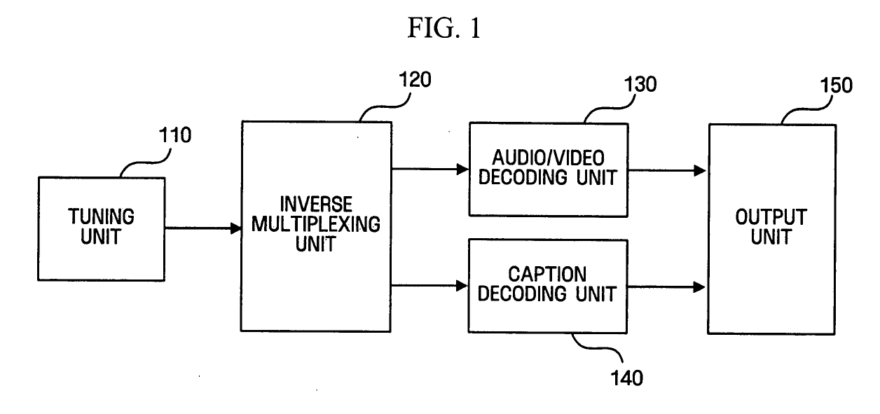

FIG. 2 is a timing diagram illustrating outputs of video and captions according to the related art;

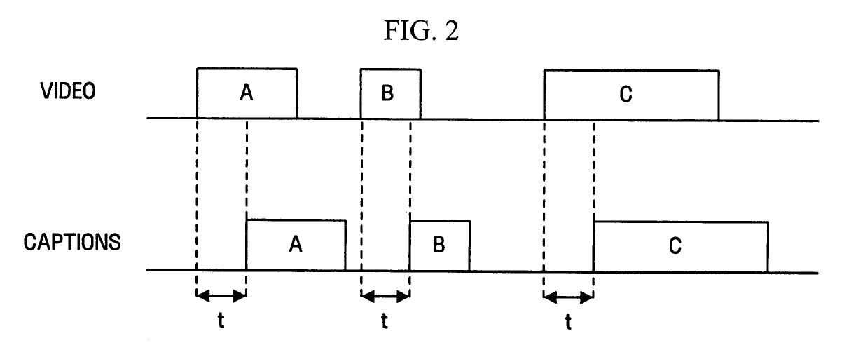

FIG. 3 is a block diagram illustrating an apparatus for coordinating synchronization of video and captions according to an exemplary embodiment of the present invention;

FIG. 4 illustrates caption data written by a markup language according to an exemplary embodiment of the present invention;

FIG. 5 is a flow chart illustrating method for coordinating synchronization of video and captions according to an exemplary embodiment of the present invention;

FIG. 6A is a timing diagram illustrating synchronization coordination according to an exemplary embodiment of the present invention;

FIG. 6B is a timing diagram illustrating synchronization coordination according to another exemplary embodiment of the present invention;

FIG. 6C is a timing diagram illustrating synchronization coordination according to a further another exemplary embodiment of the present invention; and

FIG. 6D is a timing diagram illustrating synchronization coordination according to a still further another exemplary embodiment of the present invention.

### DETAILED DESCRIPTION OF EXEMPLARY EMBODIMENTS OF THE INVENTION

Hereinafter, exemplary embodiments according to the present invention will be described in greater detail with reference to the accompanying drawings. The present invention may, however, be embodied in many different forms and should not be construed as being limited to the exemplary embodiments set forth herein. Rather, these exemplary embodiments are provided so that this disclosure will be thorough and complete and will fully convey the concept of the invention to those skilled in the art, and the present invention will only be defined by the appended claims. Like reference numerals described herein refer to like elements throughout the specification and drawings.

For a better understanding of the present invention, synchronization of video data and caption data will be described. However, since audio data is generally synchronized with video data, its synchronization is not described in detail herein, since synchronization of audio data and caption data may be analogized from the following description.

Exemplary embodiments of the present invention will be described in more detail with reference to the accompanying drawings.

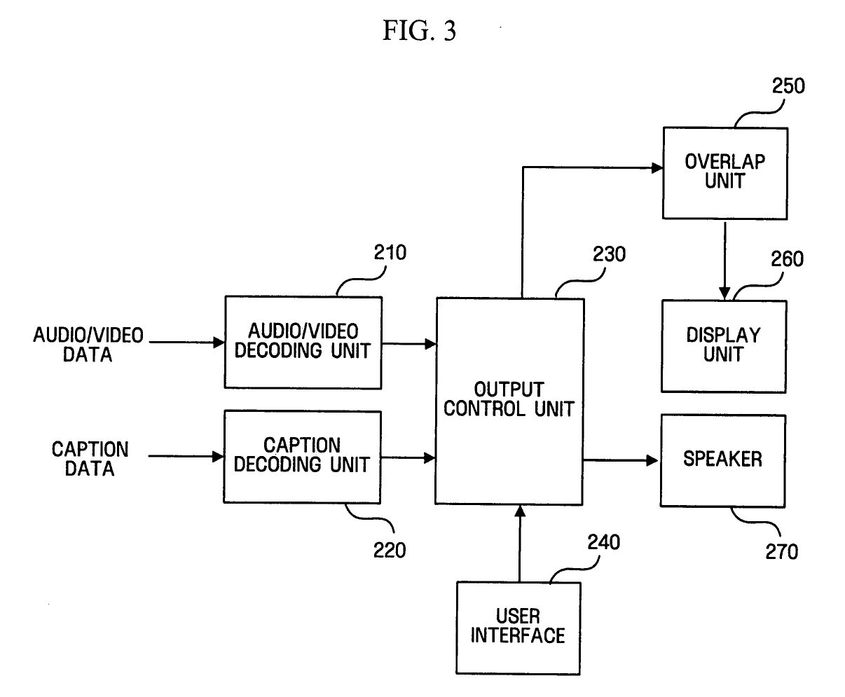

FIG. 3 is a block diagram illustrating an apparatus for coordinating synchronization of video and captions according to an exemplary embodiment of the present invention.

As illustrated in FIG. 3, the apparatus for coordinating synchronization of video and captions comprises an audio/video decoding unit 210 to decode input video data and audio data, a caption decoding unit 220 to decode caption data, and an output control unit 230 to coordinate synchronization of the captions and video.

The apparatus for coordinating synchronization of video and captions further comprises a user interface unit 240 through which the apparatus receives control information input by a user in order to synchronize video and captions, an overlap unit 250 to overlap captions to be output with the video, a display unit 260 to display overlapped captions and video, and a speaker 270 to output sound.

The audio/video decoding unit 210 decodes input video and audio data, and the caption decoding unit 220 decodes input caption data.

Input video data, audio data, and caption data may be obtained by inversely multiplexing broadcast signals received from a broadcasting station. However, the present invention is not limited thereto, and, for example, the input video, sound, and caption data may come from a predetermined storage medium.

Input video data may include control information to synchronize the outputs of video and captions. For example, a broadcast provider measures time consumed while a text converter perceives a speaker's voice and outputs text information according thereto. The broadcast provider may include information about the measured time in the video data as control information. Accordingly, the control information included in the video data can be used to synchronize the outputs of the video and captions.

Also, the control information to synchronize video and captions may be included in the caption data.

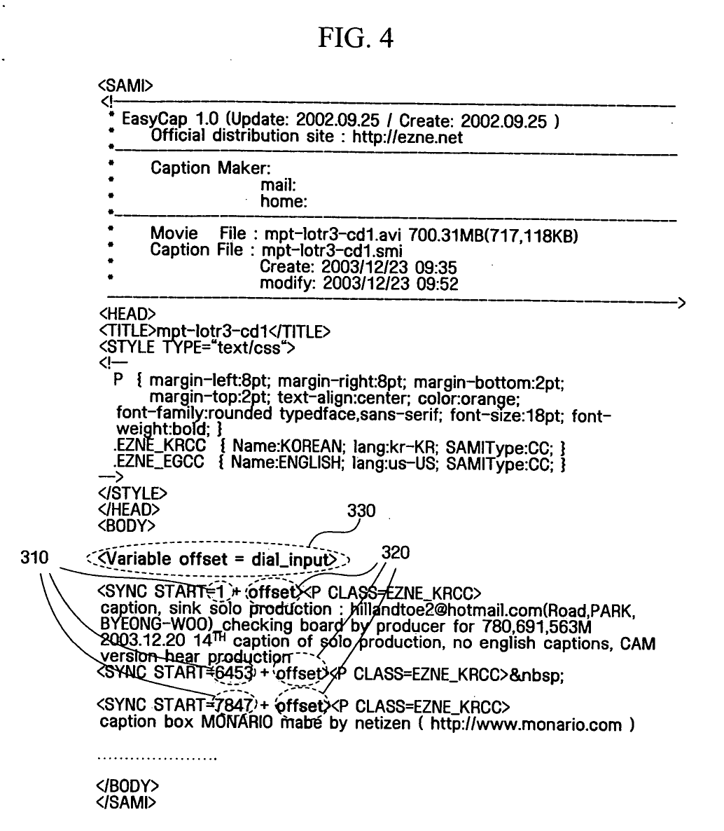

According to an exemplary embodiment of the invention, input caption data may comprise a predetermined markup document, which will be described later with reference to FIG. 4.

The output control unit 230 coordinates synchronization of the decoded video data, audio data, and caption data. When the decoded video data or caption data includes control information to synchronize video and captions, the output control unit 230 may synchronize the video and captions based on the control information included in the video data or caption data.

For example, when the control information contained in the input video data or caption data details that the caption data is delayed by the time interval t, the output control unit 230 may delay output of the video data by the time interval t. This delay can be performed by outputting the video data to the overlap unit 250 after buffering it by the time interval t. As a result, the caption data is synchronized with the video data.

Even when a user inputs arbitrary control information through the user interface unit 240 to synchronize captions and video, the output control unit 230 may coordinate synchronization of the video and captions. For example, when a user requests display of video data to be delayed by a predetermined time interval t, the output control unit 230, having received user input control information through the user interface unit 240, may delay output of the video data by the time interval t as indicated by the control information. This delay can be performed by outputting the video data to the overlap unit 250 after buffering it by the time interval t. As a result, video output is delayed by the time interval t so that it coincides with the captions. Accordingly, although broadcast signals do not include information for synchronization of video and captions, the user can coordinate the synchronization of the video and captions.

According to the present invention, even when a broadcast in which video and captions are normally synchronized is received, the time difference of outputting the video and captions may be coordinated by a user. For example, even when a captioned broadcast is received that is synchronized, such as a recorded broadcast, if the user requests the video to be displayed a time interval t later than the captions, the output control unit 230, which received user input control information from the user interface unit 240, can output the video data to the overlap unit 250 after buffering it by the time interval t as indicated by the control information. Thus, even when the captioned broadcast is synchronized, output of the captions may precede the video by the time interval requested by the user.

Similarly, the user may delay output of the captions by any predetermined time interval. For this purpose, the output control unit 230 may output the caption data to the overlap unit 250 after buffering it by the time interval requested by the user.

When the output control unit 230 delays output of the video data, the audio data can also be delayed in the same manner to synchronize output of the audio data with output of the video data.

When video data, audio data and caption data are buffered in order to delay their output, the output control unit 230 may include a storage means to store the data for a predetermined time. This storage means may be a non-volatile, readable, writable and erasable memory such as flash memory.

The input caption data may be a predetermined markup document, which will be described with reference to FIG. 4.

FIG. 4 illustrates caption data written in a markup language according to an exemplary embodiment of the present invention.

The illustrated caption data is written in a synchronized multimedia integration language (SMIL). The caption data comprises first synchronization information 310 to synchronize captions with video, and second synchronization information 320 to be set according to control information input by a user. The caption data indicates that the second synchronization information 320 may also be coordinated according to input control information in the line 330.

Generally, the first synchronization information 310 indicates a time point for normal output of captions to video. The second synchronization information 320 indicates a time point for output of captions to video through an operation with the first synchronization information 310. The second synchronization information 320 may be modified according to the control information from the user, and thus, the captions can be output at the time point requested by the user.

For example, the output control unit 230 sets the second synchronization information 320 according to control information input through the user interface unit 240 (e.g., to be 10), and outputs the captions at the time point indicated as a result of an operation using the first synchronization information 310 and the second synchronization information 320. In the illustration, the operation using the first synchronization information 310 and the second synchronization information 320 is addition (+). When the second synchronization information 320 is set to 10, the output time point of the captions of each synchronization line (SYNC START line) would be 11(=1+10), 6463(=6453+10), and 7857(=7858+10), according to the illustration.

The second synchronization information 320 may be set as a negative number. When there is no input of control information to set the second synchronization information 320, the output control unit 230 may determine the time point for output of captions to video based only on the first synchronization information 310.

Thus, the output control unit 230 may output the captions earlier or later than the output time point indicated by the first synchronization information 310, or it may output the captions at the output time point as indicated by the first synchronization information 310.

The overlap unit 250 displays the captions and video outputted from the output control unit 230 through the display unit 260 after overlapping them.

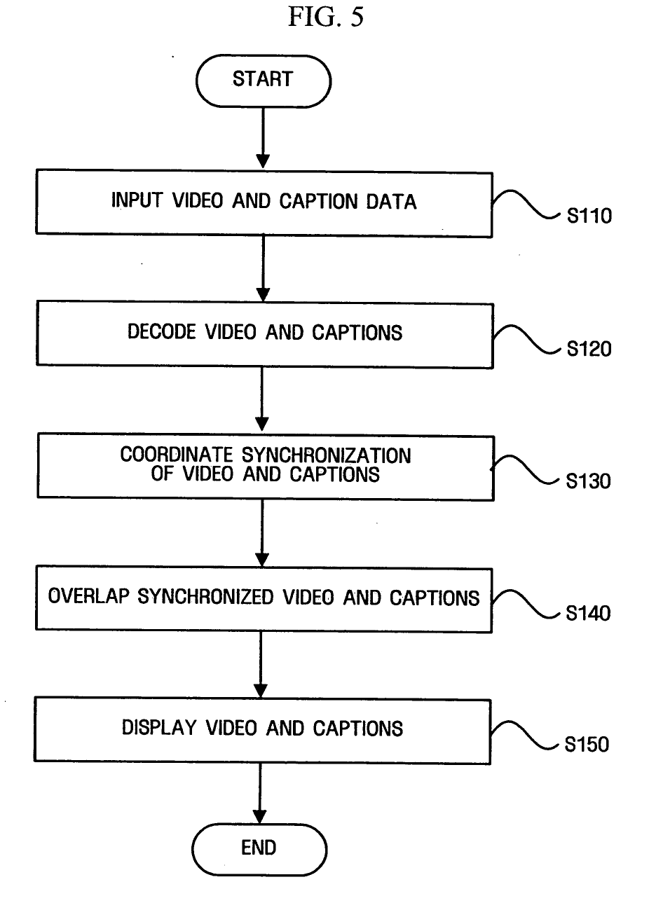

FIG. 5 is a flow chart illustrating method for coordinating synchronization of video and captions according to an exemplary embodiment of the present invention.

When video data and caption data are first input S110, the audio/video decoding unit 210 decodes the input video data and the caption decoding unit 220 decodes the input caption data S120. IF audio data is input, the audio/video decoding unit 210 can decode the input audio data.

At this time, input video data, audio data and caption data may be obtained by inversely multiplexing broadcast signals received from a broadcasting station. However, the present invention is not limited thereto; the input video, sound and caption data may be stored in a predetermined storage medium. The input caption data may be a predetermined markup document, which was described above with reference to FIG. 4.

Decoded data are transmitted to the output control unit 230, and the output control unit 230 coordinates synchronization of decoded video data and caption data according to the predetermined control information S130. When control information for synchronizing the video and captions is included in the decoded video data or caption data, the output control unit 230 may synchronize the video and captions based on this information.

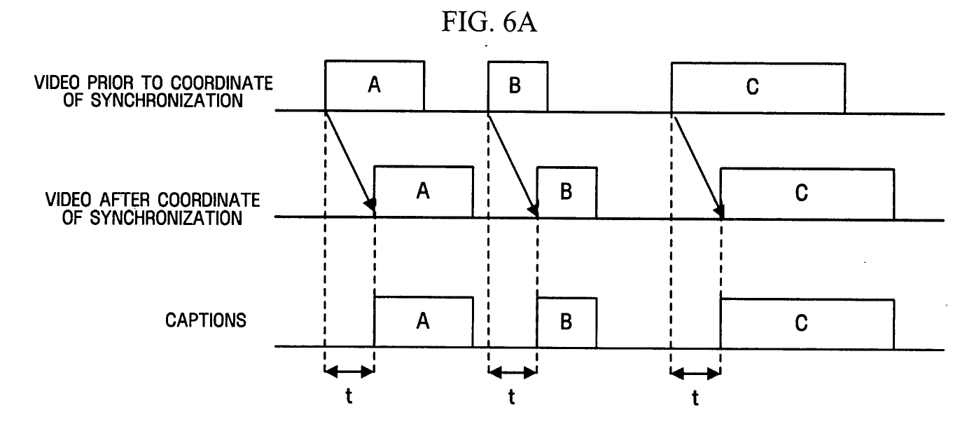

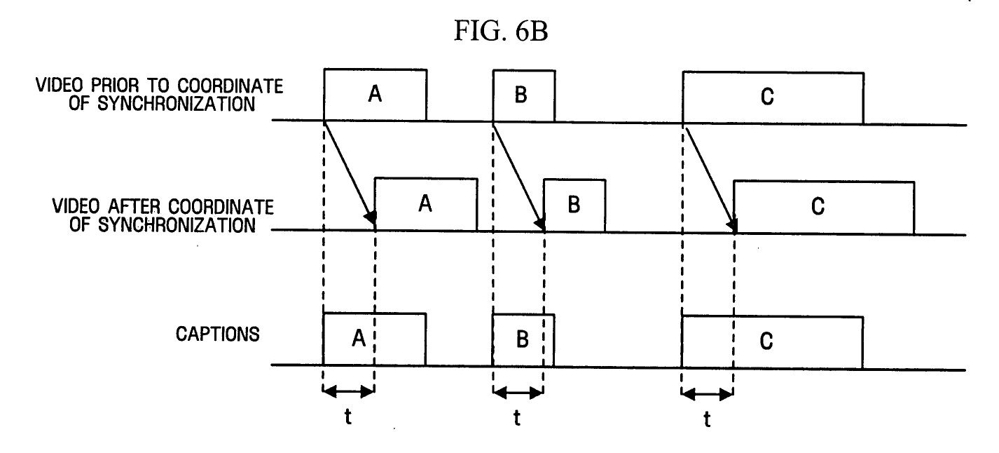

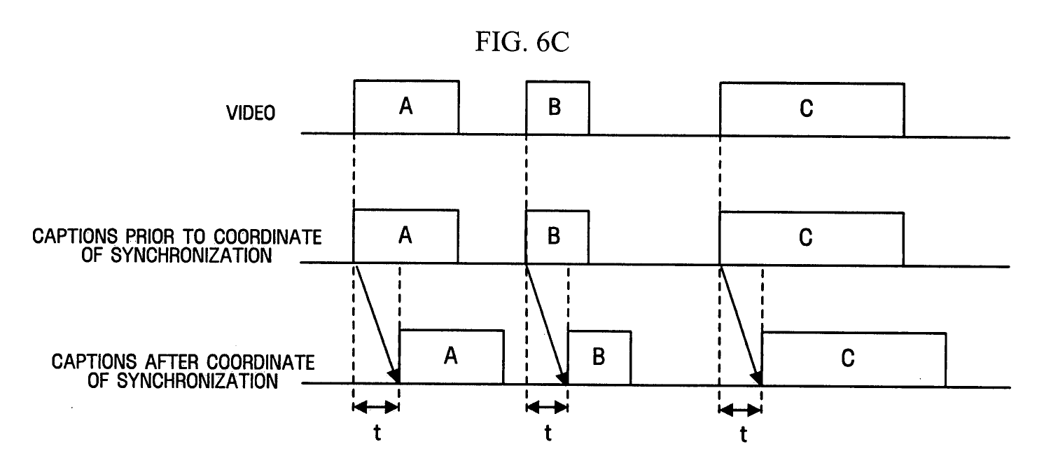

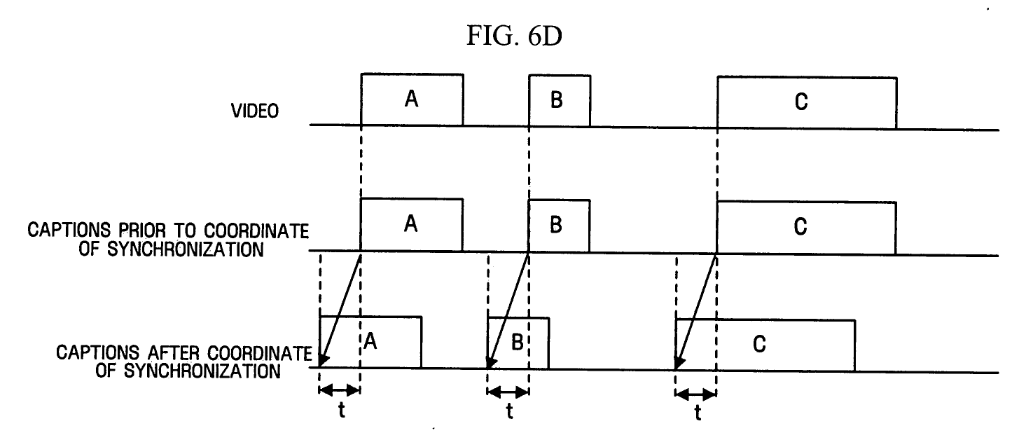

For example, when the control information contained in the input video data or caption data indicates that the caption data is delayed by the time interval t, the output control unit 230 may delay output of the video data by the time interval t. This delay can be performed by outputting the video data to the overlap unit 250 after buffering it for the time interval t. As a result, the caption data is synchronized with the video data. A timing diagram showing the results of synchronization of video and captions is illustrated in FIG. 6A. Prior to coordinating the synchronization, the captions are delayed by the time of t, later than the video. However, by delaying output of the video data by the time of t, synchronization of the video and captions is achieved.

Even when a user inputs arbitrary control information through the user interface unit 240 to coordinate synchronization of captions and video, the output control unit 230 can coordinate synchronization of the video and captions. For example, when a user requests video to be displayed by the predetermined time interval t, the output control unit 230 having received the user input control information from the user interface unit 240 may delay output of the video data by the time interval t as indicated by the control information. This delay can be performed by outputting the video data to the overlap unit 250 after buffering it for the time interval t. As a result, the video output is delayed by the time interval t, because of the control information input. Accordingly, although broadcast signals do not include information for synchronization of video and captions, the user can coordinate the synchronization of the video and captions.

According to the present invention, even when a broadcast in which video and captions are normally synchronized is received, the time difference of outputting the video and captions may be coordinated at the user's request. For example, even when a captioned broadcast that has been synchronized (e.g., a recorded broadcast) is received, if the user requests the video to be displayed after the time interval t, the output control unit 230, having received the user input control information from the user interface unit 240, can output the video data to the overlap unit 250 after buffering it for the time interval t as indicated by the control information. Thus, although the captioned broadcast normally synchronized is received, output of the captions may be precede the corresponding video by the time interval requested by the user. This synchronization of video and captions is illustrated in FIG. 6B. Prior to coordinating the synchronization, video and captions are simultaneously output. However, by delaying output of the video data by the time interval t, output of the captions precedes the video by the time interval t.

Similarly, the user may delay output of the captions for a predetermined time interval. For this purpose, the output control unit 230 may output the caption data to the overlap unit 250 after buffering it for the time interval requested by the user. Results of synchronization of captions and video are illustrated in FIG. 6C. Referring to this figure, it can be seen that output of the captions is delayed by the time interval t when video is outputted.

When the output control unit 230 delays the output of the video data, the audio data may also be delayed in the same manner to synchronize output of the audio data with output of the video data.

As described above with reference to FIG. 4, even when the input caption data is in the format of a predetermined markup document, the caption data may also be output earlier or later than the corresponding video, by coordinating the synchronization information set in the caption data (the second synchronization information). Results of coordinating this synchronization can be seen in FIGS. 6C and 6D.

The video and caption data whose synchronization is coordinated by the output control unit 230 are transmitted to and overlapped by the overlap unit 250 S140, and the overlapped video and captions are displayed through the display unit 260 S150.

As described above, synchronization of video and captions can be coordinated to cope with any demand from a user, according to the apparatus and method for coordinating synchronization of video and captions of the present invention.

It will be understood by those of ordinary skill in the art that various replacements, modifications and changes in form and details may be made therein without departing from the spirit and scope of the present invention as defined by the following claims. Therefore, it is to be appreciated that the above described exemplary embodiments are for purposes of illustration only and not to be construed as a limitation of the invention.

What is claimed is:

1. An apparatus for coordinating synchronization of video and captions, comprising:
a first decoding unit to decode video data;
a second decoding unit to decode caption data; and
an output control unit to control an output time of at least one of decoded caption data and decoded video data according to predetermined control information.

2. The apparatus of claim 1, wherein the control information is information regarding a delay time for outputting the at least one of decoded caption data and decoded video data.

3. The apparatus of claim 2, wherein the output control unit buffers and outputs one of the decoded video data and the decoded caption data according to the delay time.

4. The apparatus of claim 2, wherein the information regarding the delay time is included in at least one of the video data and the caption data.

5. The apparatus of claim 2, wherein the delay time is coordinated by a user.

6. The apparatus of claim 1, wherein the caption data comprises a predetermined mark-up document.

7. The apparatus of claim 6, wherein the mark-up document comprises first synchronization information to indicate a time point for outputting the captions with the decoded video, and second synchronization information to indicate a time point for outputting the captions with the decoded video, through an operation with the first synchronization information, which is coordinated by the control information.

8. The apparatus of claim 7, wherein the output control unit sets the second synchronization information according to the control information and synchronizes output of the captions as a result of an operation using the first synchronization information and the set second synchronization information.

9. A method for coordinating synchronization of video and captions, comprising:
decoding video data;
decoding caption data; and
controlling output of at least one of decoded caption data and decoded video data according to predetermined control information.

10. The method of claim 9, wherein the control information is information regarding the delay time for outputting the at least one of decoded caption data and decoded video data.

11. The method of claim 10, wherein the controlling output comprises:
buffering the decoded video data or the decoded caption data according to the delay time; and
outputting one of the buffered decoded video data and the decoded caption data.

12. The method of claim 10, wherein the information regarding the delay time is included in at least one of the video data and the caption data.

13. The method of claim 10, wherein the delay time is coordinated by a user.

14. The method of claim 9, wherein the caption data comprises a predetermined mark-up document.

15. The method of claim 14, wherein the mark-up document comprises first synchronization information to indicate a time point for outputting the captions with the decoded video and second synchronization information to indicate a time point for outputting the captions with the decoded video, through an operation using the first synchronization information, which is coordinated by the control information.

16. The method of claim 15, wherein the output control includes setting the second synchronization information according to the control information and synchronizing output of the captions as a result of an operation using the first synchronization information and the set second synchronization information.

17. An apparatus for coordinating synchronization of video, audio, and captions, comprising:
a decoding unit to decode one or more of video data, audio data, and caption data; and
an output control unit to control an output time of at least one of decoded caption data, decoded video data, and decoded audio data according to predetermined control information.

18. A method for coordinating synchronization of video, audio, and captions, comprising:
decoding one or more of video, audio, and caption data; and
controlling output of decoded caption data, decoded video data, and decoded audio data according to predetermined control information.
